(19) United States
(12) Patent Application Publication
(10) Pub. No.: US 2009/0181464 A1
(43) Pub. Date: Jul. 16, 2009

(54) ACCURATE MAGNETIC BIOSENSOR

(75) Inventors: Femke Karina De Theije, Eindhoven (NL); Albert Hendrik Jan Immink, Eindhoven (NL)

Correspondence Address: PHILIPS INTELLECTUAL PROPERTY & STANDARDS, P.O. BOX 3001, BRIARCLIFF MANOR, NY, 10510, US

(73) Assignee: KONINKLIJKE PHILIPS ELECTRONICS N.V., EINDHOVEN (NL)

(21) Appl. No.: 12/299,775

(22) PCT Filed: Apr. 24, 2007
(86) PCT No.: PCT/IB2007/051509

§ 371 Date: Nov. 6, 2008

(30) Foreign Application Priority Data
May 9, 2006 (EP) 06113686.7

(51) Int. Cl. G01N 27/00

(52) U.S. Cl. 436/150

(57) ABSTRACT

A method is provided for determining the concentration of target in a fluid sample using a magnetic label and a magnetic sensor for detection. It was surprisingly found that efficient and accurate measurements can be carried out by determination of a signal as soon as the signal has reached a specified threshold level. In an alternative embodiment, a displacement step is used as soon as the signal has reached a pre-defined threshold level.

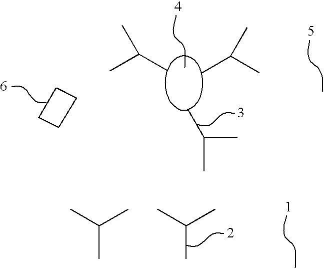

The present invention relates to a method of determining a concentration of at least one sort of polarizable or polarized magnetic labels in a fluid using the sensing device.

In the field of diagnostics, especially in biomedical diagnostics, such as medical and food diagnostics for both in vivo and in vitro application, but also for animal diagnostics, diagnostics on health and disease, or for quality control, the usage of biosensors or biochips is well known. These biosensors or biochips are generally used in the form of micro-arrays of biochips enabling the analysis of biological entities such as e.g. DNA (desoxyribonucleic acid), RNA (ribonucleic acid), proteins or small molecules, for example hormones or drugs. Nowadays, there are many types of assays used for analysing small amounts of biological entities or biological molecules or fragments of biological entities, such as binding assays, competitive assays, displacement assays, sandwich assays or diffusion assays. The challenge in biochemical testing is presented by the low concentration of target molecules (e.g. pmol.l¹ and lower) to be detected in a fluid sample with a high concentration of varying background material (e.g. mmol.l¹). The targets can be biological entities like peptides, metabolites, hormones, proteins, nucleic acids, steroids, enzymes, antigens, haptens, drugs, cell components, or tissue elements. The background material or matrix can be urine, blood, serum, saliva or other human-derived or non-human-derived liquids or extracts. Labels attached to the targets improve the detection limit of a target. Examples of labels are optical labels, colored beads, fluorescent chemical groups, enzymes, optical barcoding or magnetic labels.

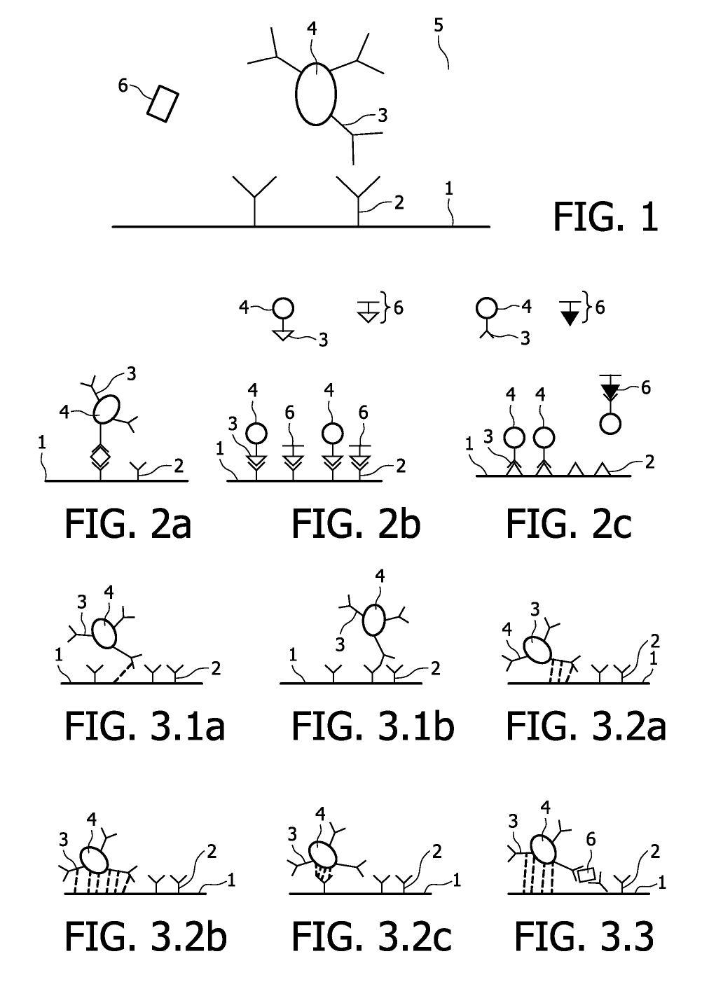

Biosensors generally employ a sensing surface 1 with specific binding sites 2 equipped with capture molecules. These capture molecules can specifically bind to other molecules or molecular complexes present in the fluid. Other capture molecules 3 and labels 4 facilitate the detection. This is illustrated in FIG. 1, which shows a biosensor sensing surface 1 to which capture molecules are coupled providing binding sites 2 to other biological entities, e.g. the target molecules 6 or targets 6. Solution 5 contains targets 6 and labels 4 to which further capture molecules 3 are coupled.

Targets 6 and labels 4 are allowed to bind to the binding sites 2 of the biosensor sensing surface 1 in a specific manner which is hereinafter called “specifically attached”.

In the Figures, bio-active entities (e.g. capture molecules 3 or binding sites 2) are sketched as being directly coupled to a solid carrier (e.g. sensor surface 1 or label 4). As is known in the art, such bio-active layers are generally linked to a solid carrier via intermediate entities, e.g. a buffer layer or spacer molecules. Such intermediate entities are added to achieve a high density and high biological activity of molecules on the surface. For clarity and simplicity, the intermediate entities are omitted in the Figures.

In contrast to this biological attachment to the sensing surface 1, labels 4 can also attach to the sensing surface 1 in a non-specific or non-biological manner, i.e. bind to the surface 1 without mediation of the specific target molecules 6.

In a magnetic biosensor, the measurement of the concentration of beads specifically bound to the surface can be perturbed by the presence of unbound or non-specifically bound beads. Therefore, a reliable data point can only be taken when unbound and non-specifically bound beads are removed from the surface.

Further, biological assays generally take a very long time to reach equilibrium. In practice, measurements are done far before equilibrium is reached.

One method that is suitable to reduce the measurement time is the so-called kinetic measurement. This method relies on the measurement of a signal as a function of time. The method is specified in more detail in the detailed description of this application.

To be able to do a kinetic measurement that is specific only for the specifically bound beads, the following sequence is generally applied in a cyclic manner:

pull the beads towards the surface; there binding may take place;

then the beads must be pulled from the surface, to distinguish between beads specifically binding to the surface and non-specific binding or unbound beads;

after this displacement step one can measure the actual signal.

In point-of-need testing, e.g. roadside through-the-window testing for drugs-of abuse in saliva, e.g., for traffic safety, it is essential to provide for testing equipment that is sufficiently robust to be used on a day-to-day basis and to provide for a testing method yielding results that are sufficiently quick and precise.

It is an object of the present invention to provide a method for target analysis that is quick and accurate.

### SUMMARY OF THE INVENTION

In a first aspect of the present invention, a sensing method is provided for determining the concentration of at least one sort of targets (6) in a fluid (5) containing at least one sort of polarizable or polarized magnetic labels (4) using a magnetic sensing device comprising a sensing surface (1), the method comprising the steps of:

providing a fluid (5) comprising at least one sort of magnetic labels (4) over the sensing surface (1);

pulling the magnetic labels towards the surface;

determining the signal that is generated by the labels, characterised in that the determination of the signal is started as soon as the signal has achieved a pre-defined threshold level.

In a further aspect, the invention relates to a method which further comprises a displacement step comprising removing labels from, or moving them to one side of, the sensor surface, to distinguish between beads specifically binding to the surface and non-specific binding or unbound beads, wherein the displacement step is carried out as soon as the signal has reached the pre-defined threshold level.

In the claimed method, the target concentration is most preferably determined by combining the determined signal with the time between start of incubation with magnetic label and determination of the signal, or the time between start of incubation with magnetic label and the displacement step.

### DETAILED DESCRIPTION

The present invention will be described with respect to particular embodiments and with reference to certain drawings, but the invention is not limited thereto but only by the claims. The drawings described are only schematic and are non-limiting. In the drawings, the size of some of the elements may be exaggerated and not drawn to scale for illustrative purposes.

Where an indefinite or definite article is used when referring to a singular noun, e.g. “a”, “an”, “the”, this includes a plural of that noun unless something else is specifically stated.

Furthermore, the terms first, second, third and the like in the description and in the claims are used for distinguishing between similar elements and not necessarily for describing a sequential or chronological order. It is to be understood that the terms so used are interchangeable under appropriate circumstances and that the embodiments of the invention described herein are capable of operation in other sequences than described or illustrated herein.

Moreover, the terms top, bottom, over, under and the like in the description and the claims are used for descriptive purposes and not necessarily for describing relative positions. It is to be understood that the terms so used are interchangeable under appropriate circumstances and that the embodiments of the invention described herein are capable of operation in other orientations than described or illustrated herein.

It is to be noticed that the term “comprising”, used in the present description and claims, should not be interpreted as being restricted to the means listed thereafter; it does not exclude other elements or steps. Thus, the scope of the expression “a device comprising means A and B” should not be limited to devices consisting only of components A and B. It means that with respect to the present invention, the only relevant components of the device are A and B.

In the following, the present invention will mainly be described with reference to magnetic labels, also called magnetic beads or beads. The magnetic labels are not necessarily spherical in shape, but may be of any suitable shape, e.g. in the form of spheres, cylinders or rods, cubes, ovals etc. or may have no defined or constant shape. By the term “magnetic labels” is meant that the labels include any suitable form of one magnetic particle or more magnetic particles, e.g. magnetic, diamagnetic, paramagnetic, superparamagnetic, ferromagnetic, that is any form of magnetism which generates a magnetic dipole in a magnetic field, either permanently of temporarily. For performing the present invention, there is no limitation to the shape of the magnetic labels, but spherical labels are presently the easiest and cheapest to manufacture in a reliable way. The size of the magnetic labels is not per se a limiting factor of the present invention. However, for detecting interactions on a biosensor, small-sized magnetic labels will be advantageous. When micrometer-sized magnetic beads are used as magnetic labels, they limit the downscaling because every label occupies an area of at least 1 μm². Furthermore, small magnetic labels have better diffusion properties and generally show a lower tendency to sedimentation than large magnetic beads. According to the present invention, magnetic labels are used in the size range between 1 and 3000 nm, more preferably between 5 and 500 nm.

The method according to the present invention is specifically suitable for determination of the concentration of biological entities in a fluid.

In the present description and claims of the invention, the term “biological entities” should be interpreted broadly. It includes bioactive molecules such as proteins, peptides, RNA, DNA, lipids, phospholipids, carbohydrates like sugars, or the like. The term “biological entities” also includes cell fragments such as portions of cell membranes, particularly portions of cell membranes which may contain a receptor. The term biological entities also relates to small compounds which potentially can bind to a biological entity. Examples are hormones, drugs, ligands, antagonists, inhibitors and modulators. The biological entities can be isolated or synthesized molecules. Synthesized molecules can include non-naturally occurring compounds such as modified amino acids or nucleotides. The biological entities can also occur in a medium or fluid such as blood or serum or saliva or other body fluids or secretions, or extracts, or tissue samples or samples from cell cultures, or any other samples comprising biological entities such as food, feed, water samples et cetera.

The present invention provides a method of determining the concentration of at least one sort of targets, especially biological entities, in a complex biological sample.

In this invention, it is particularly preferred to determine the concentration of targets by calculating the ratio between the concentration of labels specifically attached and the concentration of labels not attached, i.e. the ratio between the binding rate (represented by the concentration of the magnetic labels on the sensor surface) and the rate of exposure (represented by the concentration of the magnetic labels in the bulk of the liquid). The concentration of targets according to the invention is proportional to the parameter ε, which is a parameter that represents the fractional occupancy of binding moieties, which are present on label 4 or on sensor surface 1, depending on the type of assay. This parameter is related to the target concentration in the fluid, in a manner that depends on the assay.

These and other characteristics, features and advantages of the present invention will become apparent from the following detailed description, taken in conjunction with the accompanying drawings, which illustrate, by way of example, the principles of the invention. The description is given by way of example only, and is not to be construed as limiting the scope of the invention. The reference numbers quoted below refer to the attached drawings.

FIG. 1 illustrates a biosensor to which first capture molecules are coupled in a solution comprising targets and labels to which second capture molecules are coupled.

FIGS. 2a, 2b, 2c, 3.1a, 3.1b, 3.2a, 3.2b, 3.2c, 3.3 illustrate some examples of possible binding configurations of labels 4 to a biosensor sensing surface.

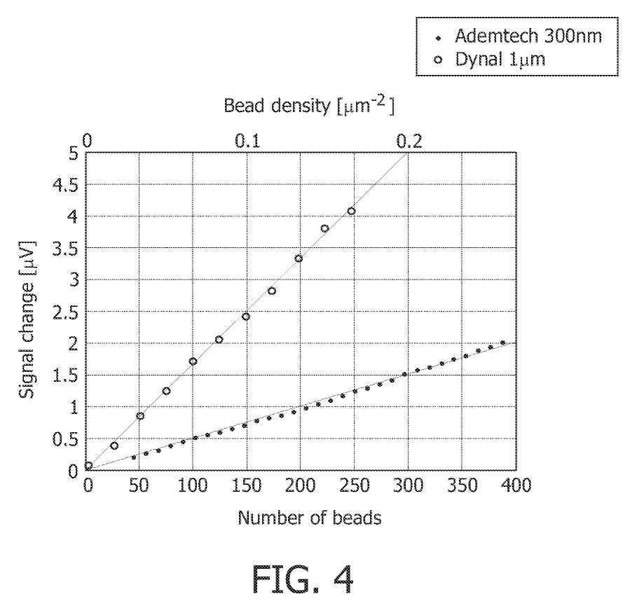

FIG. 4 shows a plot of number of beads versus signal.

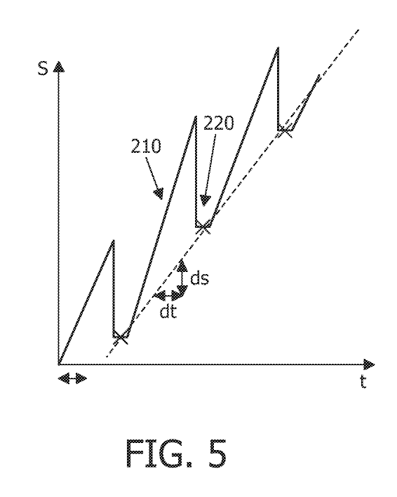

FIG. 5 sketches the signal of a sensor that is sensitive to labels bound to the surface and, to a certain extent, to unbound beads in the vicinity of the sensor surface. The signal is sketched as a function of time, and it is described how the slope of the surface-binding curve can be derived.

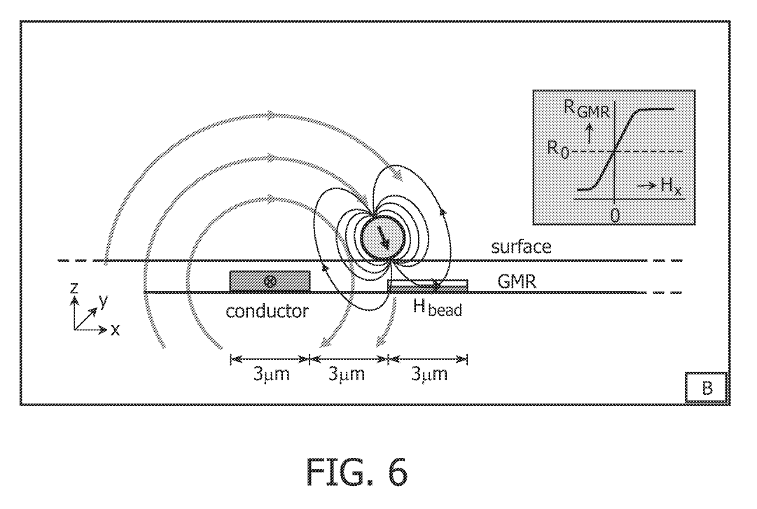

FIG. 6 is a sketch of a sensor cross-section with a magnetic label on the chip surface.

In biological assays it is common practice to carefully tune the amount of labelled compounds (e.g. antibodies) that needs to be added to the assay medium. An excess of labels would lead to an insensitive assay, because too many labels will bind to the sensor surface in a non-specific manner. A shortage of labels would lead to a decreased signal-to-noise ratio. In many assays, the assay is run to completion and the final signal is measured after completion.

It was surprisingly found that to obtain a reproducible assay, the start time for the measurement of the specific signal that is generated by specifically bound magnetic labels, and the start time for magnetic washing (a displacement step), is not determined by the measurement time but by comparing the signal level of the sedimentation curve with a fixed, predefined threshold level for the signal. This means that in the method according to the invention, the signal measurement and the start time of an optional displacement step are determined by the signal reaching a pre-defined threshold level. This threshold level represents a minimum number of magnetic beads being specifically linked to the sensor surface. In combination with a kinetic measurement, this provides accurate measurement points in a relatively short time frame.

Therefore, in a first aspect, the invention relates to a method of determining the concentration of at least one sort of targets (6) in a fluid (5) containing at least one sort of polarizable or polarized magnetic labels (4) using a magnetic sensing device comprising a sensing surface (1), the method comprising the steps of:

providing a fluid (5) comprising at least one sort of magnetic labels (4) over the sensing surface (1);

pulling the magnetic labels towards the surface;

determining the signal that is generated by the labels,

wherein the determination of the signal is started as soon as the signal has achieved a pre-defined threshold level.

This pre-defined threshold level may be determined individually for each magnetic sensor set up.

The method according to the invention offers the following advantages.

Firstly, the assay becomes less sensitive to the number of captured beads in terms of signal to thermal noise and signal to statistical noise. Secondly, the assay can be carried out in an optimised, short time frame because the only waiting time is the time needed to fulfil the accuracy requirements of the test. Thirdly, the size/magnetic susceptibility spread becomes less important. The presence of some large beads or beads with high magnetic susceptibility is averaged over a reasonably well-defined number of beads. This is important because commercially available magnetic bead preparations may show a significant spread in size and magnetic susceptibility.

As explained above, magnetic biosensors are generally made to be as sensitive as possible to beads specifically bound to the sensor surface. However, the measurement of the concentration of specifically bound beads (or labels) to the surface can be perturbed by the presence of unbound or non-specifically bound beads (or labels). Therefore, a reliable data point for measuring a target concentration through a label concentration is preferably taken when unbound and/or non-specifically bound beads are removed from the surface. Such removal of non-specifically bound beads from the surface is for example done in a displacement step which is also referred to as washing step. In magnetic sensors, such a washing step is often carried out as magnetic washing. In magnetic washing a magnetic field is used to gently pull away the non-specifically bound beads from the sensor surface. The force applied is sufficiently strong to remove the non-specifically bound beads and sufficiently weak to keep the specifically bound beads in place.

Therefore, the following sequence or cycle is preferably applied, either once or in a repeated manner:

the beads are pulled towards the surface; thereby binding may take place;

then the beads can be moved away from, or to one side of, the sensor surface, to distinguish between beads specifically binding to the surface and non-specific binding or unbound beads;

after this displacement step one can measure the actual signal of specifically bound beads.

Hence, in a preferred aspect, the invention relates to a method which further comprises a displacement step comprising removing the labels from, or moving them to one side of, the sensor surface to distinguish between beads specifically binding to the surface and non-specific binding or unbound beads, wherein the displacement step is carried out as soon as the signal has achieved a pre-defined threshold level.

The preferred, predefined threshold level for measuring the signal and for starting the optional magnetic washing is the signal that is generated by Nb magnetic beads specifically attached to the sensor surface, which beads are applied as labels in this method.

Waiting for the signal to reach a pre-defined threshold level guarantees a minimum number of magnetic beads on the sensor. This guarantees a minimum signal-to-noise ratio both for the signal-to-thermal noise and the signal-to-statistical noise. The statistical noise is due to the random arrival process of beads on the surface. A histogram of the number of beads on the surface after a fixed time for a large number of tests in the same conditions (ensemble) will lead to a Poisson distribution. This means that the variance in the number of beads depends on the mean number of captured beads Nb. This variance is equal to sqrt(Nb) leading to a signal-to-statistical noise ratio of Nb/sqrt(Nb). For a 3% variation, Nb needs to be at least 1,000 because 1,000/sqrt(1.000)=1.000/32=32. Now one can calculate or measure the signal level corresponding to 1,000 beads. This was done for beads of 300 and 1000 nm (see FIG. 4). From this plot one can see that 100 beads give 0.5 microV (for 300 nm beads), i.e. 1,000 beads would give 5 microV. The sensor that was used to obtain this plot is specified below.

The thermal noise is given by the resistance of the sensor (in a specific example 500 Ohm nominally) if the electronics is designed properly. The root mean square (rms) thermal noise voltage is then equal to Un=sqrt(4 kTR*BW), where k is Boltzmann's constant, T is the absolute temperature, R is the sensor resistance and BW is the bandwidth of the measurement (i.e. the bandwidth of the electronics). This means that the rms thermal noise voltage is 2.8 nV/sqrt(Hz). This means that in situations with a limited bandwidth (in most cases enough for biological measurements) the statistical noise is dominant. In a preferred system, Nb is chosen larger than 1000 to achieve a variation, due to a statistical variation in the number of specifically bound beads, smaller than 3%. Note that the time for the assay in this preferred embodiment now varies depending on the target concentration. The target concentration may be extracted from the measured signal and from the time needed between the start of incubation with magnetic label and measuring the signal, or alternatively from the measured signal and from the time needed between the start of incubation with magnetic label and the displacement step.

The method according to the invention is preferably combined with a kinetic measurement of the target concentration. The kinetic measurement is described below.

FIG. 5 sketches the signal of a sensor that is sensitive to labels bound to the surface and, to a certain extent, to unbound beads in the vicinity of the sensor surface. The signal is sketched as a function of time, and it is described how the slope of the surface-binding curve can be derived. In the context of the present invention, the surface-sensitive signal is also called the raw signal of the target-dependent sensor signal S. The above-mentioned sequence or cycle is used to determine the slope of the surface-sensitive signal represented by the dotted line. The signal represented by the dotted line is identical to the target-dependent sensor signal S. Therefore, the measured slope of this signal leads to a determination of the target concentration in the fluid sample. The above mentioned sequence or cycle is also represented in FIG. 5, where reference sign 210 denotes the step of allowing labels near the surface or pulling labels to the surface, and where reference sign 220 denotes the step of removing labels or pulling labels from the surface.

The signal during the step denoted by reference sign 210 is caused by beads binding to the sensor surface as well as by unbound beads in the vicinity of the sensor surface. Using the signals during the steps denoted by reference signs 210 and 220, the surface-bound signal as well as the signal due to unbound beads can be derived. As a result, the concentration of labels in the solution as well as the concentration of labels bound to the sensor surface can be derived. According to the present invention, these two measurements lead to a very accurate determination of the target concentration in the fluid.

In this preferred embodiment, the slope of the curve is proportional to the binding rate of labels to the sensor surface. The average slope dS/dt of the signal during the measurement time tₘ is given by the signal S (at the end of tₘ) divided by the measurement time tₘ. The target concentration is related to the binding rate, in a manner that depends on the assay. The target concentration can be very accurately determined when the signal is recorded with a high signal-to-noise ratio. In the case of detection by a magneto-resistive biosensor, a high signal-to-noise ratio can be achieved by the use of high currents. High currents can cause heating or irreversibly change biomaterials. However, when signals are measured at the endpoint of the assay, heating and changes of the biomaterials are not important. In other words, endpoint signals (i.e. specifically bound labels and/or unbound labels in the solution in the vicinity of the binding sites) can be measured with a very high signal-to-noise ratio, which enhances the precision of determination of the target concentration. It will be appreciated that this requires that enough beads did bind specifically to the sensor surface within the time set for the incubation.

In general, a sensing device will be sensitive to labels specifically attached to the sensing surface (Type 1 binding, cf. above) as well as to labels that are not specifically attached but still in the vicinity of the sensing surface. This second alternative can be realised either by label binding to the sensing surface in the manner of Type 2 or by labels not attached to the sensing surface, but located in the vicinity of the surface.

According to the present invention, these different magnetic label concentrations are either measured independently or the signal that is measured is so strong compared to the bulk signal that there is no need to measure the bulk signal. It is within the capabilities of the skilled person to estimate the ratio between the signal from specifically bound beads and the bulk signal (for example by performing several experiments at different, known target concentrations). The estimate of the ratio can be used to generate an estimate of the number of specifically bound beads (that remain after displacement) in order to determine the pre-defined level at which displacement should take place to ensure that at least Nb beads remain at the sensor surface after the displacement step.

According to one embodiment of the invention, it is, for example, possible to differentiate the specifically attached magnetic labels from other labels through the differences in rotational and/or translational mobility of specifically attached labels versus non-specifically attached labels and labels that are not attached. For example, it is possible to apply magnetic fields and to determine mobility-dependent signals. Such magnetic fields can also be modulated, e.g. by current wires or magnets, to attract magnetic labels to the sensing surface, or to repel magnetic labels from the sensing surface, or to move magnetic labels over the sensing surface. A comparison of the signal of the magnetic sensor element for the different positions of the magnetic labels allows determination of the number of mobile magnetic labels in the vicinity of the sensing surface, said mobile magnetic labels being present in the solution to be measured.

In a further preferred embodiment of the present invention, the magnetic field-generating means is a two-dimensional wire structure located on the sensing device.

As previously described, a sensing device will be sensitive to labels specifically attached to the sensing surface (Type 1 binding) as well as to labels that are not specifically attached but still in the vicinity of the surface, e.g. Type 2 label binding or labels not attached to the sensing surface, but in the vicinity of the sensing surface. According to the present invention, these different magnetic label concentrations are preferably measured independently.

For all embodiments of the sensing device, the magnetic sensor element may be one of an AMR (Anomalous Magneto Resistive), a GMR (Giant Magneto Resistive) or a TMR (Tunnel Magneto Resistive) sensor element. Of course, magnetic sensor elements based on other principles like Hall sensor elements or SQUIDs (Superconducting QUantum Interference Devices) are also suitable for use according to the present invention.

The device may be equipped for a range of different assay formats, e.g. competitive, inhibition, displacement, sandwich assays. As is known in the art, the biochemical and chemical species (e.g. targets, target-like molecules, labels, binding sites) can be brought together at once or sequentially. For enhanced speed, it is advantageous to bring the reagents together at once. In the latter case, the kinetics of the processes and the factual sequence of binding processes depend e.g. on the diffusion and binding speeds.

Note that the sensor or chip substrate can be any suitable mechanical carrier, of organic or inorganic material, e.g. glass, plastic, silicon, or a combination of these. In a preferred embodiment of the sensing device 10, an electronic circuit 30 is provided in the substrate 20. The electronic circuit 30 is provided to collect signals or data collected or measured by a magnetic sensor element 11 located in the substrate 20. In an alternative embodiment of the present invention, the electronic circuit 30 can also be located outside the substrate 20.

The magnetic field generating means 13 may, for example, be magnetic materials (rotating or non-rotating) and/or conductors such as, e.g., current wires 13. In the embodiment described, the magnetic field-generating means 13 is preferably generated by means of current wires. Detection of rotational and/or translational movement of labels 4 may preferably be performed magnetically. In the first as well as the following embodiments of the present invention, the magnetic detection may preferably be performed by using the integrated magnetic sensor element 11. Various types of sensor elements 11 may be used such as, e.g., a Hall sensor, magneto-impedance, SQUID, or any suitable magnetic sensor. The magnetic sensor element 11 is preferably provided as a magnetoresistive element, for example, a GMR or a TMR or an AMR sensor element 11. A means for generating a rotating magnetic field can be provided by means of current wires as well as current-generating means integrated in the substrate 20 of the sensing device 10. The magnetic sensor element 11 may have, e.g., an elongated (long and narrow) strip geometry. The rotating magnetic field is thus applied to the magnetic labels 4 by means of current flowing in the integrated current wires. Preferably, the current wires may be positioned in such a way that they generate magnetic fields in the volume where magnetic labels 4 are present.

In a preferred embodiment, the following sensor is applied. This is the sensor that was used for obtaining the data of FIG. 4.

A sketch of a sensor cross-section with a magnetic label on the chip surface is presented in FIG. 6. An excitation current that flows through the integrated conductors produces the excitation field. The stray field from a label that is magnetized by the excitation field results in a resistance variation of the GMR sensor.

The detection platform typically supplies a 1.1 mA_{RMS} sinusoidal sense current (Iₛ) with a frequency (fₛ) of 1 MHz to the GMR and a 25 mA_{RMS} sinusoidal excitation current (Iₑ) with a frequency (fₑ) of 1.05 MHz to both excitation wires of the sensor. This results in a difference signal at 50 kHz, denoted as the magnetic signal. The frequencies of the sense and excitation currents are chosen such that the frequency of the magnetic signal (fₘ) is as low as possible to facilitate amplification. However, to maintain optimal SNR, the frequency of the magnetic signal should be outside the range where the 1/f noise generated by the amplifier (A) is dominant over the thermal noise. Note that the 1/f noise of the GMR, which is superimposed on the sensor resistance, has shifted in the spectrum and is present around the sense current frequency (fₛ). A passive low-pass filter (LPF1) is employed to suppress the large sense signal and crosstalk (at fₑ), thereby reducing the dynamic range of the detected signal. The 50 kHz magnetic signal is subsequently amplified by a low noise amplifier and demodulated by a 50 kHz reference signal (V_{ref}) to obtain a base-band signal of which the bandwidth is determined by the speed of the biological assay. As the process of beads binding to the sensor surface is relatively slow, the bandwidth of the base-band signal is typically only a few Hz. A second low-pass filter (LPF2) suppresses the out-of-band noise. The signal is converted to the digital domain and communicated to a PC for further evaluation.

Commercially available beads were used, namely Ademtech particles with a diameter of 300 nm and a susceptibility of 4·10⁻²⁰ m³.

In this invention, emphasis was put on the application of the invention in immunoassays. It will be clear to a person skilled in the art that also assays with other targets and other binding entities can be used, e.g. assays with nucleic acids and hybridizing entities.

We note that the above invention can be combined with sensor multiplexing and/or label multiplexing. In sensor multiplexing, sensors are used with different types of binding sites 2. Also the capture molecules 3 on the labels 4 can be of different types. In label multiplexing, different types of labels 4 are used, e.g., labels with different sizes or different magnetic properties.

1. A method of determining the concentration of at least one sort of targets (6) in a fluid (5) containing at least one sort of polarizable or polarized magnetic labels (4) using a magnetic sensing device comprising a sensing surface (1), the method comprising the steps of:
providing a fluid (5) comprising at least one sort of magnetic labels (4) over the sensing surface (1);
pulling the magnetic labels towards the surface;
determining the signal that is generated by the labels,
characterised in that the determination of the signal is started as soon as the signal has achieved a pre-defined threshold level.

2. A method according to claim 1, wherein the method further comprises a displacement step comprising removing the labels from, or moving them to one side of, the sensor surface, to distinguish between beads specifically binding to the surface and non-specific binding or unbound beads, the displacement step being carried out as soon as the signal has achieved a pre-defined threshold level.

3. A method according to claim 1, wherein the concentration of target is determined at least in part by the time between the start of incubation with magnetic labels and the moment of reaching the pre-defined threshold level or the displacement step.

4. A method according to claim 1, wherein the pre-defined threshold level is the signal that is generated by Nb magnetic beads specifically attached to the sensor surface, which beads are applied as labels in this method, and Nb is chosen according to Nb/sqrt(Nb) in such a way that the expected variation is smaller than the specified required variation in the outcome of the method when performed with equal target concentrations.

5. A method according to claim 1, wherein the pre-defined threshold level is the signal that is generated for a value of Nb of at least 1000, magnetic beads attached specifically to the sensor surface.

6. A method according to claim 1, wherein the concentration of targets (6) is determined by calculating the ratio between the concentration of specifically attached labels (4) and the concentration of non-attached labels (4).

7. A method according to claim 1, that is combined with kinetic determination of the target concentration.
